(19) United States
(12) Patent Application Publication
(10) Pub. No.: US 2005/0201296 A1
(43) Pub. Date: Sep. 15, 2005

(54) Reduced channel quality feedback

(75) Inventors: Rath Vannithamby, San Diego, CA (US); Shiau-He Shawn Tsai, San Diego, CA (US); Wanshi Chen, San Diego, CA (US)

Correspondence Address: COATS & BENNETT, PLLC, P O BOX 5, RALEIGH, NC, 27602, US

(73) Assignee: Telefonaktiebolaget LM Ericsson (pu

(21) Appl. No.: 11/079,159

(22) Filed: Mar. 14, 2005

Related U.S. Application Data
(60) Provisional application No. 60/553,062, filed on Mar. 15, 2004.
(60) Provisional application No. 60/553,480, filed on Mar. 16, 2004.

(51) Int. Cl. H04J 3/14; H04J 1/16; H04L 1/00; H04L 12/26; H04B 7/212; H04J 3/16; H04J 3/00; H04J 3/22

(52) U.S. Cl. 370/241; 370/465

(57) ABSTRACT

A communication station employs discontinuous transmission of channel quality feedback to reduce channel quality feedback transmitted over overhead channels. Prior to transmitting channel quality information to a remote station, the communication station compares the channel quality feedback to predetermined qualification criteria. If the qualification criteria are not met, the channel quality feedback is not transmitted. The method may be implemented by a mobile station to reduce channel quality feedback sent to a base station over a reverse link overhead channel.

### RELATED APPLICATONS

This application claims priority to Provisional U.S. Patent Application No. 60/553,062 filed Mar. 15, 2004; and No. 60/553,480 filed Mar. 16, 2004, which are incorporated herein by reference.

### BACKGROUND OF THE INVENTION

The present invention relates to mobile communication systems and, more particularly, to techniques for reducing signaling overhead on overhead channels.

The demand for wireless data services, such as mobile Internet, video streaming, and voice over IP, have led to the development of high speed packet data channels to provide high data rates needed for such services. High speed packet data channels are employed on the forward link in cdma2000 (both 1xEV-DV and 1x-EV-DO) and High Speed Downlink Packet Data Access (HSPDA) systems. The high speed packet data channel is a shared channel. In 1xEV-DV systems, the forward link packet data channel is known as the Forward Packet Data Channel (F-PDCH). Transmissions from a base station to the mobile stations are time-multiplexed and transmitted at full power. At any given time, the base station transmits to only one mobile station. The slot times and data rates allocated for transmissions to the mobile stations depend on the channel conditions seen by each mobile station. The mobile stations measure the signal quality on the forward link and send channel quality information on the reverse link overhead channels to the base station. The channel quality information may comprise either a channel quality indicator (CQI) in 1xEV-DV and HSPDA, or a data rate indication in 1xEV-DO. The base station selects a forward link data rate and assigns slot times for a mobile station based on the channel quality feedback from that mobile station. The base stations may also vary the modulation and encoding used for the forward link channel, depending on the channel conditions and/or the requested data rate.

Currently, in 1xEV-DV, 1xEV-DO and HSPDA systems, a mobile station assigned to the forward packet data channel sends channel quality information at a predetermined frequency regardless of channel conditions. When the number of mobile stations assigned to the forward packet data channel is large, the feedback of channel quality information consumes significant reverse link resources and consequently reduces significantly reverse link capacity. When channel conditions between a mobile station and the base station are unfavorable, a mobile station is unlikely to be scheduled to receive data on the forward packet data channel. When the likelihood of being scheduled is low, transmission of channel quality information from a mobile station to the base station consumes reverse link resources thereby reducing reverse link capacity without any increase in the capacity of the forward link channel, or other noticeable benefit. Also, when channel conditions are stable and do not change significantly from one reporting period to the next, it is not necessary to send full channel quality information to the base station. Channel quality feedback could be reduced by omitting information from that is not changing from one reporting period to the next.

### SUMMARY OF THE INVENTION

A mobile station employs discontinuous transmission of control information to reduce transmission over reverse link overhead channels. Prior to transmitting control information to the base station, the mobile station compares the control information to predetermined qualification criteria. If the qualification criteria are not met, the control information is not transmitted.

In one exemplary embodiment, the mobile station receives packet data transmissions from the base station on the forward link over a shared packet data channel. The mobile station sends channel quality feedback to the base station for use in scheduling packet data transmissions on the forward packet data channel. The channel quality feedback comprises a channel quality indicator (CQI) that is sent periodically in a CQI report. When generating a CQI report, the mobile station may compare the CQI value for the current reporting period to a predetermined channel quality threshold. If the CQI value is less than the channel quality threshold, the mobile station does not send the CQI report.

In another embodiment of the invention, the channel quality feedback may comprise a rate indication sent by the mobile station to the base station. Transmission of the rate indication may be qualified by comparing the rate indication for a current reporting period to a rate indication for a previous reporting period. If the rate indication has changed, the mobile station sends the rate indication. On the other hand, if the rate indication has not changed, the mobile station does not send the rate indication.

In another embodiment of the invention, the mobile station may transmit rate control information on a reverse link overhead channel in support of packet data transmissions from the mobile station to the base station on a reverse packet data channel. Discontinuous transmission may be applied to all or part of the control information. For example, the rate control information may include a data rate indication to indicate the data rate at which the mobile station is transmitting a frame on a corresponding reverse packet data channel. If the data rate is unchanged from a previous frame, the mobile station may omit the data rate from the control message.

### BRIEF DESCRIPTION OF THE DRAWINGS

FIG. 1 illustrates an exemplary mobile communication network.

FIG. 2 illustrates an exemplary base station for a mobile communication network.

FIG. 3 illustrates an exemplary mobile station for a mobile communication network.

FIG. 4 is a flow chart illustrating a first exemplary discontinuous transmission procedure implemented by a mobile station for qualifying transmission of a channel quality indicator.

FIG. 5 is a flow chart illustrating a second exemplary discontinuous transmission procedure implemented by a mobile station for qualifying transmission of a data rate indication.

FIG. 6 is a flow chart illustrating a third exemplary discontinuous transmission procedure implemented by a mobile station for qualifying transmission of control information sent over a reverse overhead channel.

### DETAILED DESCRIPTION OF THE INVENTION

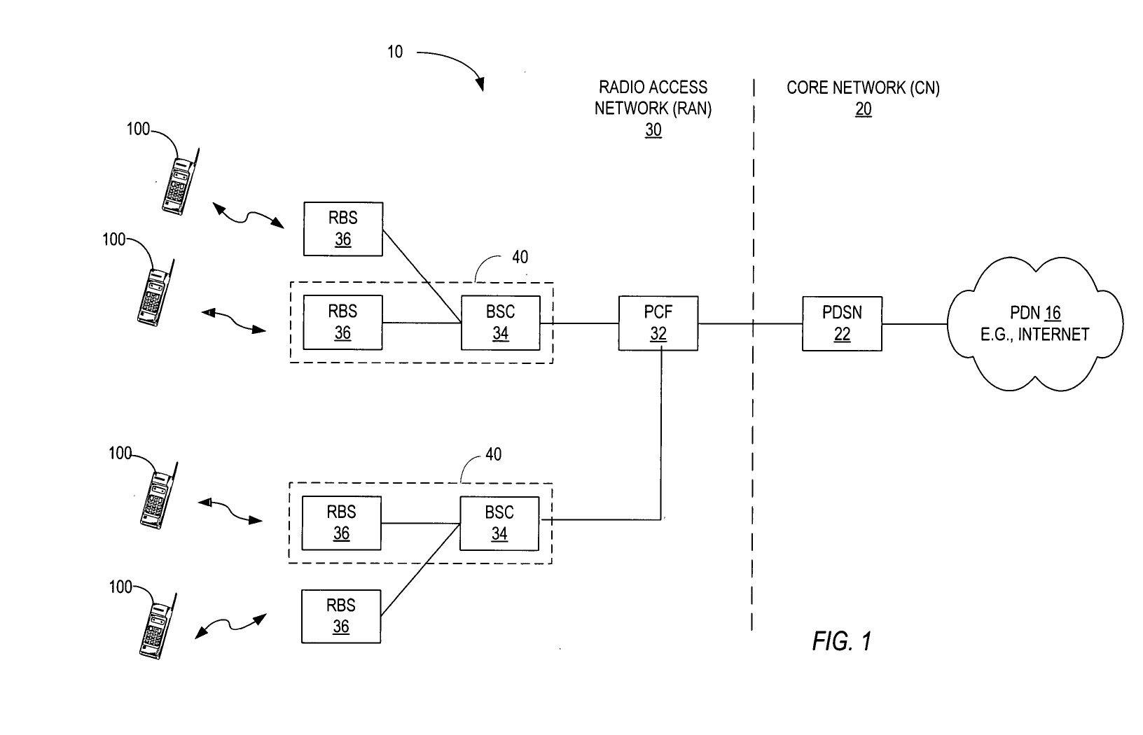

FIG. 1 illustrates logical entities of an exemplary wireless communication network 10 that provides packet data services to mobile stations 100. FIG. 1 illustrates a wireless communication network 10 configured according to the 1xEV-DV (IS2000) standards. Other standards, including 1xEV-DO (IS856), High Speed Packet Downlink Access (HSPDA) and Orthogonal Frequency Division Multiplexing (OFDM), could also be employed.

The wireless communication network 10 is a packet-switched network that employs a high-speed forward packet data channel (F-PDCH) to transmit data to the mobile stations 100. Wireless communication network 10 comprises a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile station 100. Core network 20 adds and removes IP streams to and from the RAN 30 and routes packets between the external packet data network 16 and the RAN 30.

RAN 30 connects to the core network 20 and gives mobile stations 100 access to the core network 20. RAN 30 includes a Packet Control Function (PCF) 32, one or more base station controllers (BSCs) 34 and one or more radio base stations (RBSs) 36. The primary function of the PCF 32 is to establish, maintain, and terminate connections to the PDSN 22. The BSCs 34 manage radio resources within their respective coverage areas. The RBSs 36 include the radio equipment for communicating over the air interface with mobile stations 100. A BSC 34 can manage more than one RBSs 36. In cdma2000 networks, a BSC 34 and an RBS 36 comprise a base station 40. The BSC 34 is the control part of the base station 40. The RBS 36 is the part of the base station 40 that includes the radio equipment and is normally associated with a cell site. In cdma2000 networks, a single BSC 34 may comprise the control part of multiple base stations 40. In other network architectures based on other standards, the network components comprising the base station 40 may be different but the overall functionality will be the same or similar.

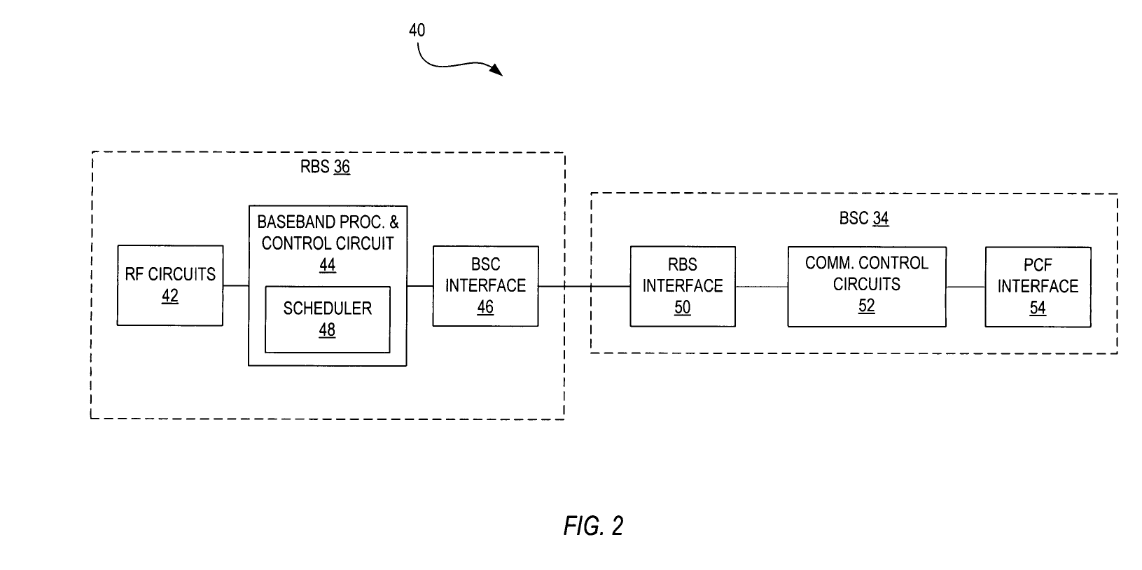

FIG. 2 illustrates exemplary details of a base station 40 in a cdma2000 network. The base station components in the exemplary embodiment are distributed between a RBS 36 and a BSC 34. The RBS 36 includes RF circuits 42, baseband processing and control circuits 44, and interface circuits 46 for communicating with the BSC 34. the baseband processing and control circuit 44 performs baseband processing of transmitted and received signals. In the embodiment shown in FIG. 2, the baseband processing and control circuit 44 includes a scheduler 48 to schedule packet data transmissions on the Forward Packet Data Channel (F-PDCH). The baseband processing and control circuit 44 may be implemented in software, hardware, or some combination of both. For example, the baseband processing and control circuit 44 may be implemented as stored program instructions executed by one or more microprocessors or other logic circuits included in RBS 36.

The BSC 34 includes interface circuits 50 for communicating with the RBS 36, communication control circuits 52, and interface circuits 54 for communicating with the PCF 32. The communication control circuits 52 manage the radio and communication resources used by the base station 40. Resources managed by the communication control circuits include, for example, Walsh codes and transmit power. The communication control circuits is responsible for setting up, maintaining and tearing down communication channels between the RBS 36 and mobile station 100. The communication control circuits may allocate Walsh codes and perform power control functions. The communication control circuits 52 may be implemented in software, hardware, or some combination of both. For example, the communication control circuits 52 may be implemented as stored program instructions executed by one or more microprocessors or other logic circuits included in BSC 34.

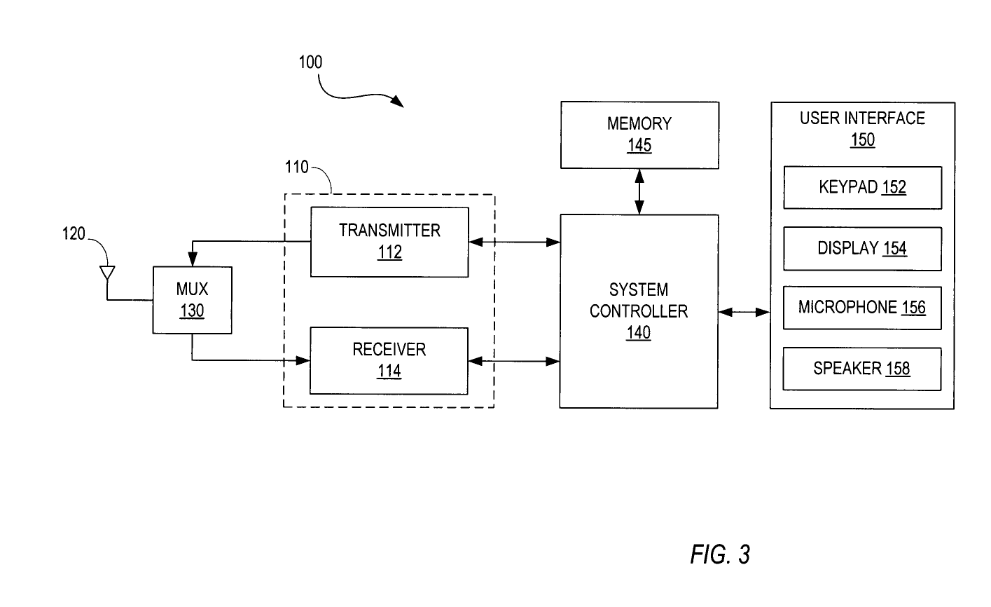

FIG. 3 is a functional block diagram of an exemplary mobile station 100 according to one embodiment of the present invention. As used herein, the term “mobile station” may include a cellular radiotelephone, a Personal Communications System (PCS) terminal that may combine a cellular radiotelephone with data processing, facsimile, and data communications capabilities; a Personal Data Assistant (PDA) that may include a pager, Web browser, radiotelephone, Internet/intranet access, organizer, calendar, and a conventional laptop and/or palmtop receiver or other appliances that include a radiotelephone transceiver.

Mobile station 100 includes a transceiver 110 connected to an antenna 120 via a multiplexer 130 as known in the art. Mobile station 100 further includes a system controller 140, memory 145, and a user interface 150. Transceiver 110 includes a transmitter 112 to transmit signals to mobile stations 100 and a receiver 114 to receive signals from mobile stations 100. Transceiver 110 may, for example, operate according to the cdma2000 or WCDMA standards. The present invention, however, is not limited to use with these standards and those skilled in the art will recognize the present invention may be extended or modified for other standards. For example, the transceiver may comprise a Multiple-Input, Multiple-Output (MIMO) transceiver or an Orthogonal Frequency Division Multiplexing (OFDM) transceiver.

System controller 140 provides overall operational control for the mobile station 100 according to programs instructions stored in memory 145. System controller 140 may comprise one or more microprocessors or microcontrollers and may be part of an application specific integrated circuit (ASIC). Memory 145 represents the entire hierarchy of memory in a mobile station 100. Memory 145 provides storage for data, operating system programs and application programs. Memory 145 may be integrated with the system controller 140, or may be implemented in one or more discrete memory devices.

User interface 150 comprises input device such as a keypad 152, display 154, microphone 156 and speaker 158. Input device 152 and display 154 allows the operator to interact with the mobile station 100. Microphone 156 converts the operator's speech into electrical audio signals and speaker 158 converts audio signals into audible signals that can be heard by the operator. It will be understood by those skilled in the art that mobile station 100 may comprise a subset of the illustrated user interface elements, or mobile station 100 may comprise additional user interface elements not shown or described herein.

The RBS 36 communicates with a plurality of mobile stations 100. In the exemplary embodiment, the RBS 36 transmits packet data to the mobile stations 100 over a shared forward packet data channel (F-PDCH). Transmissions from the RBS 36 to the mobile stations 100 are time-multiplexed and transmitted at full power. At any given time, the RBS 36 transmits to only one mobile station 100. The slot times and data rates allocated for transmissions to the mobile stations 100 depend on the channel conditions seen by each mobile station 100. The mobile stations 100 measure the channel quality on the forward link and send channel quality information on reverse link overhead channels to the RBS 36. The channel quality information may comprise a channel quality indicator (CQI) in 1xEV-DV and HSPDA systems. In 1xEV-DO systems, the channel quality information comprises a data rate indication sent to the RBS 36 over the Data Rate Control (DRC) channel. The RBS 36 assigns slot times and data rates for a mobile station 100 based on the channel quality feedback from that mobile station 100. Scheduling is performed by the scheduler 48. The RBS 36 may also vary the modulation and encoding used for the forward link channel, depending on the channel conditions and/or the requested data rate.

Currently, in 1xEV-DV, 1xEV-DO and HSPDA systems, a mobile station 100 assigned to the F-PDCH sends channel quality information at a predetermined update frequency regardless of channel conditions. In 1xEV-DV systems, the mobile station 100 sends CQI reports to the RBS 36 every 1.25 ms on the Reverse Channel Quality Indicator (R-CQIICH). The CQI report may be 4-bits for a full CQI or 1-bit for a differential CQI. In 1xEV-DO systems, a mobile station 100 assigned to the forward Traffic Channel (FTC) sends a DRC report to the RBS 36 every 1.66 ms over the Reverse Data Rate Control Channel. The DRC report indicates the highest supportable data rate, which may considered a form of channel quality information since the supportable data rate will depend on the existing channel conditions. When the number of mobile stations 100 assigned to the F-PDCH is large, the feedback of channel quality information consumes significant reverse link resources and consequently reduces significantly reverse link capacity. This will be particularly true in communication systems that use where there are multiple transmit and/or receive antennas such as MIMO systems and OFDM systems.

When channel conditions between a mobile station and the RBS 36 are unfavorable, a mobile station 100 is not likely to be scheduled to receive data on the F-PDCH because the scheduler 48 at the RBS 36 will favor those mobile stations 100 with better channel conditions. When channel conditions are poor, and thus the likelihood of being scheduled is low, transmission of channel quality information from a mobile station 100 to the RBS 36 consumes reverse link resources thereby reducing reverse link capacity without any increase in the capacity of the forward link channel, or other noticeable benefit. To prevent unnecessary waste of reverse link resources, one exemplary embodiment of the present invention employs a discontinuous transmission technique on the reverse link overhead channels to suppress channel quality feedback when channel conditions are unfavorable. As used herein the term channel quality feedback includes feedback of a desired data rate, such as the DRC feedback in 1xEV-DO systems.

The underlying idea behind the discontinuous transmission scheme is to free up reverse link resources by sending channel quality feedback to the RBS 36 only when such feedback is likely to be useful. Using the discontinuous transmission technique, the mobile station can determine dynamically in response to changing channel conditions whether to send channel quality feedback. The decision to send or not send channel quality information can be made on a frame-by-frame basis at the mobile station.

The specific implementation of discontinuous transmission on the reverse link overhead channels may vary depending upon the type of scheduler 48 used at the RBS 36. The scheduling algorithm used at the RBS 36 may consider, in addition to channel conditions, various fairness criteria and quality of service factors in making scheduling decisions. The RBS 36 may instruct the mobile station 100 to send channel feedback information only if certain qualification criteria are met. In one embodiment of the invention, the RBS 36 may send a CQI threshold to the mobile station 100. When the mobile station 100 is in a discontinuous transmission mode for the reverse link overhead channels, the mobile station 100 performs channel quality measurements and generates CQI values normally. The CQI value is a quantized measurement of the channel conditions. Before sending the CQI values to the RBS 36, the mobile station 100 compares the generated CQI values with the CQI threshold provided by the RBS 36. If the generated CQI value is less than the threshold, the mobile station 100 suspends or suppresses CQI reporting. As long as the generated CQI values remain below the CQI threshold, the mobile station 100 will not send the CQI report to the RBS 36. The mobile station 100 will resume CQI reporting when channel conditions improve so that the generated CQI values meet the CQI threshold. When comparing generated CQI values with the CQI threshold, the mobile station 100 may use a filtered CQI value rather than an instantaneous CQI value so that channel quality feedback is not interrupted by transient or momentary changes in channel conditions.

The CQI threshold may be a configurable parameter that varies depending on numerous factors. One factor to consider in setting the CQI threshold is the type of application. If an application is delay-sensitive, the RBS 36 can choose a low CQI threshold so that the mobile station 100 will send CQI reports except in very bad conditions. On the other hand, if the application is delay-insensitive, a higher CQI threshold may be used to reduce the CQI reporting overhead. Another factor to consider in choosing the CQI threshold is sector loading. When sector loading is low, reverse link capacity is not likely to be a limiting factor. However, as sector loading increases, more reverse link resources will be required to support a greater number of users and it becomes more important to conserve reverse link resources. Therefore, the RBS 36 may set the CQI threshold to a low value when sector loading is low, and increase the CQI threshold as sector loading increases.

Other factors to consider in setting the CQI threshold include fairness criteria and quality of service requirements. Some scheduling algorithms, such as a proportionally fair scheduler, temper maximum throughput scheduling with a fairness criteria. For example, the scheduler may try to guarantee a certain minimum average data rate to a mobile station 100. When a mobile station 100 falls below the minimum average data rate, the mobile station 100 is given higher priority so that the mobile station 100 may be scheduled to receive data even when channel conditions are not the most favorable. A mobile station 100 is considered underserved when the fairness criteria is not met. The RBS 36 may set a low CQI threshold for underserved mobile stations while using a higher CQI threshold for mobile stations that are adequately served or over-served in terms of the applicable fairness criteria. Similarly, quality of service (QoS) requirements may be considered. QoS requirements include factors such as average data rates, delay, jitter, etc.

The RBS 36 may set the CQI threshold individually for each mobile station 100 or may broadcast a common CQI threshold over a broadcast channel to all mobile stations 100. The RBS 36 can use layer 3 signaling to transmit a CQI threshold individually to each mobile station 100. The CQI threshold may be included in layer 3 messages such as the Enhanced Channel Assignment Message (ECAM), the Universal Handoff Direction Message (UHTM), the Enhanced System Parameter Message (ESPM), and the In-Traffic System Parameter Message.

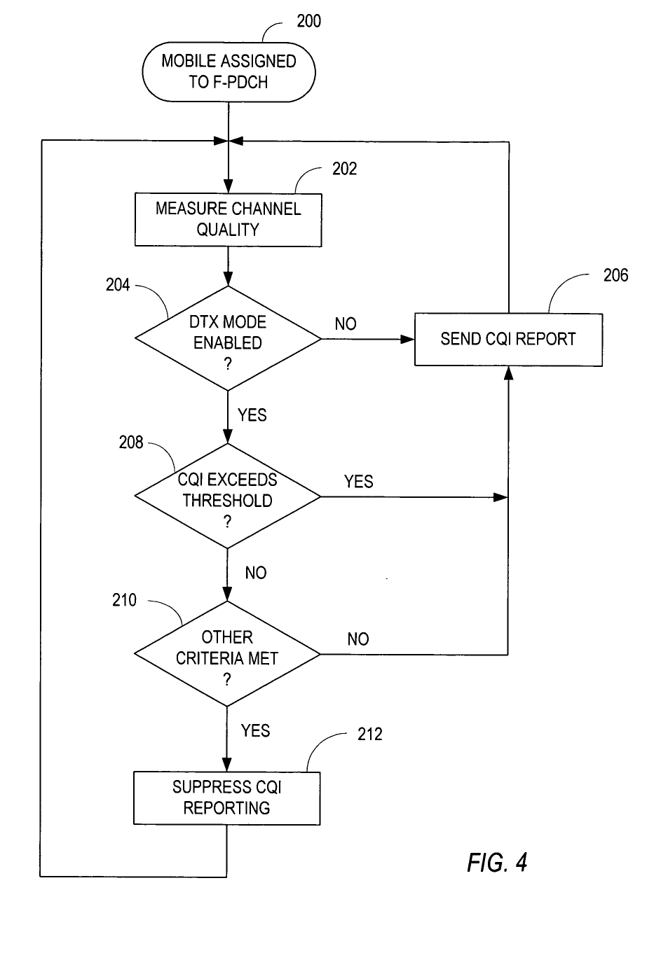

FIG. 4 illustrates a reporting procedure implemented in a mobile station 100 for reporting channel quality information to the RBS 36 according to one exemplary embodiment of the present invention. FIG. 4 illustrates a procedure for 1xEV-DV systems. The procedure is implemented when the mobile station 100 is assigned to a forward packet data channel (block 200). While the mobile station is assigned to the forward packet data channel, the mobile station 100 periodically measures the channel quality and generates a CQI value at a predetermined update frequency (block 202), which in 1XEVDV systems is once every 1.25 milliseconds. The mobile station 100 determines whether discontinuous transmission mode is enabled (block 204). If discontinuous transmission mode is disabled, the mobile station 100 sends the CQI report to the RBS 36 without further qualification (block 206). If discontinuous transmission mode is enabled, the mobile station 100 must qualify the CQI report before sending the CQI report to the RBS 36. In the exemplary embodiment shown in FIG. 4, the qualification process involves two steps. In the first step, the mobile station 100 compares the CQI value to the CQI threshold, which is stored in memory 145 (block 208). If the CQI value generated by the mobile station 100 is greater than or equal to the CQI threshold, the mobile station 100 sends the CQI report (block 206). The second step of the qualification process involves consideration of other criteria (210). The CQI reports from the mobile station 100 may be used for purposes other than scheduling on the F-PDCH. For example, a Walsh cover on the CQI report is used by the mobile station 100 for sector selection. The mobile station 100 indicates a desired serving sector by applying a Walsh cover to the CQI report. If the mobile station 100 would like to change its serving sector, it will need to send a CQI report to the RBS 36 to signal the new serving sector, regardless of channel conditions. In this case, the mobile station 100 may send a CQI report even when the CQI threshold is not met. Similarly, the CQI report may be used in some systems to power control forward link overhead channels. If the CQI report from the mobile station 100 is being used to power control forward link overhead channels, the mobile station 100 may send the CQI report.

Fairness and/or QoS criteria may also be considered in the second step of the qualification process (block 210). In this case, the mobile station 100 evaluates whether fairness or QoS requirements are satisfied. If not, the mobile station 100 sends the CQI report (block 206) even though the CQI value does not meet the minimum CQI threshold. If fairness and/or QoS criteria are met and the CQI value is less than the CQI threshold, the mobile station 100 suppresses CQI reporting (block 212). That is, the mobile station 100 does not send the CQI value to the RBS 36. As noted earlier, fairness and/or QoS criteria may be taken into account in setting the CQI threshold. In such cases, the second step of the qualification process implemented at the mobile station 100 may be omitted. In this case, the CQI report is sent or not sent, depending on whether the CQI value reaches the CQI threshold stored in memory 145 of the mobile station 100.

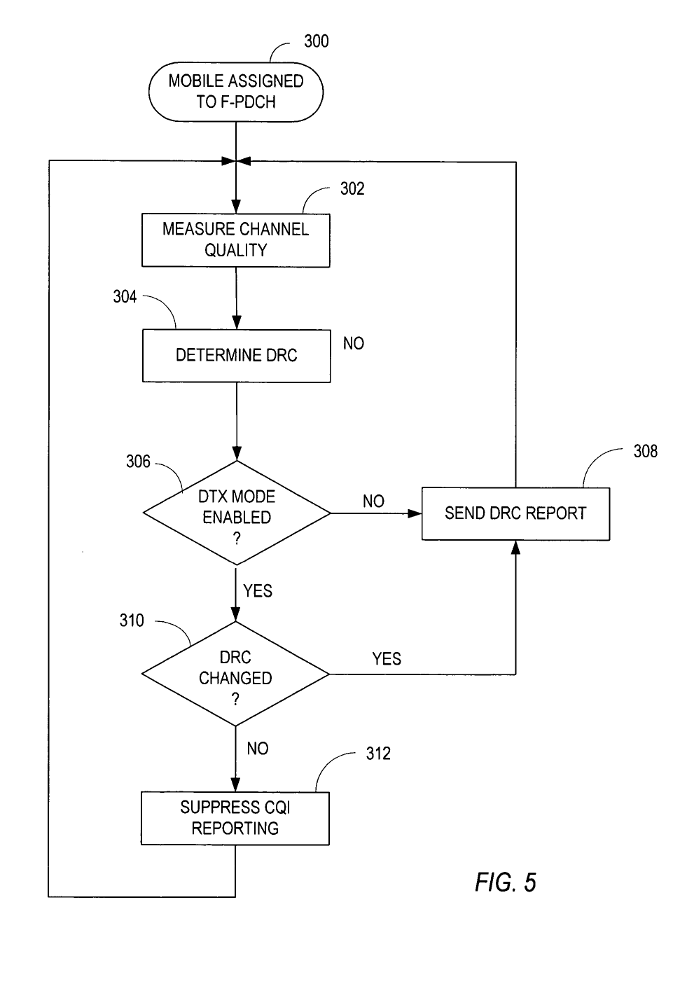

FIG. 5 illustrates one way of using the discontinuous transmission technique according to the present invention in a 1XEV-DO system. The procedure begins when the mobile station 100 is assigned to a forward packet data channel (block 300). As long as the mobile station 100 is assigned to the forward packet data channel, the mobile station 100 periodically estimates the channel quality (block 302) and generates a DRC report (block 304). The mobile station 100 determines whether discontinuous transmission mode is enabled (block 306). If not, the mobile station sends the DRC report as currently specified in the standards (block 308). If discontinuous transmission mode is enabled, the mobile station 100 compares the current DRC report with the DRC report sent in the previous reporting period (block 310). If the DRC report has changed from the previous reporting period, the mobile station 100 sends the DRC report (block 308). On the other hand, if the DRC report is unchanged, the mobile station 100 suppresses DRC reporting (block 312).

The present invention may also be used to reduce signaling on reverse link overhead channels supporting the Reverse Packet Data Channel (R-PDCH). When a mobile station 100 is transmitting to the RBS 36 on a the R-PDCH in 1xEV-DV systems, the RBS 36 transmits rate control bits (RCBs), sometimes called reverse activity bits (RABs) to the mobile station 100 over the Forward Rate Control Channel (F-RCCH) to indicate whether the mobile station 12 should increase or decrease its transmission rate on the R-PDCH or hold at its current rate. When the mobile station 100 transmits a frame of packet data on the R-PDCH, the mobile station also transmits information in a corresponding frame on the Reverse packet Data Control channel (R-PDCCH) needed to decode the transmitted packet. The information transmitted on the R-PDCCH includes the data rate used by the mobile station 100 for transmission on the R-PDCH, a subpacket identifier, and a QoS indicator. The mobile station 100 also sends a mobile status indicator bit (MSIB) to indicate that it has enough power and data to increase its data rate.

Currently, the mobile station 100 sends a full R-PDCCH frame with each R-PDCH frame. Some of the control information contained in the R-PDCCH frame, however, may not change from one frame to the next. One example of data that may not change is the data rate. If channel conditions have not changed significantly, the mobile station 100 may hold its current data transmission rate on the R-PDCH. In one embodiment of the present invention, the mobile station 100 can omit the information in the R-PDCCH frame that does not change from the previous frame. Thus, if the data rate for the currently-transmitted frame is the same as the previous frame, the mobile station 100 may omit the data rate in the R-PDCCH frame. When the RBS 36 receives an R-PDCCH frame without the data rate information, the RBS 36 will use the data rate of the previous frame for decoding the current frame. The selective transmission of the data rate information is a form of discontinuous transmission, even though the R-PDCCH is transmitted in each frame. In this case, the discontinuous transmission is applied only to specific pieces of information within the R-PDCCH.

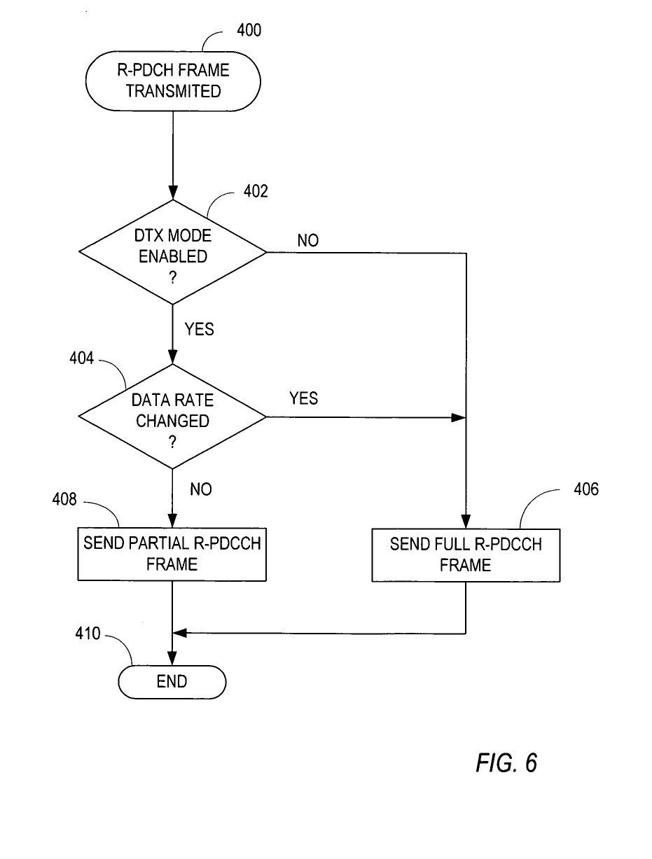

FIG. 6 illustrates an exemplary procedure implemented by the mobile station 100 to reduce signaling on the R-PDCCH. The procedure illustrated in FIG. 6 is executed when the mobile station transmits a packet on the R-PDCH (block 400). If discontinuous transmission mode is disabled (block 402), the mobile station 100 sends a full R-PDCCH frame to the RBS 36 (block 406) and the procedure ends (block 410). If DTX mode is enabled (block 402), the mobile station 100 determines whether the data rate for the current frame has changed from the previous frame (block 404). If so, the mobile station 100 transmits a full F-PDCCH frame (block 406). If the data rate is unchanged, the mobile station 100 sends a partial R-PDCCH frame (block 408) and the procedure ends (block 410).

In another embodiment of the invention, the control information that is sent on the R-PDCCH may be divided and transmitted separately on different control channels or subchannels. That is, the control information that must be transmitted in every R-PDCCH frame may be transmitted on one control channel or subchannel, and the part that does not need to be transmitted in every frame may be transmitted on a different channel. For example, the data rate information may be separated from the other control information and transmitted on a separate data rate control channel. In this embodiment, the discontinuous transmission technique described above can be applied to the new data rate control channel.

Those skilled in the art will recognize that the discontinuous transmission techniques described herein to reduce overhead on a reverse link overhead channel, can also be employed to reduce overhead on forward link overhead channels, and that the present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method of reducing channel quality feedback from a first station to a second station, said method comprising:
sending channel quality feedback from said first station to said second station over an overhead channel; and
suspending said channel quality feedback dynamically responsive to changing channel conditions.

2. The method of claim 1 further comprising:
resuming said channel quality feedback dynamically responsive to changing channel conditions after channel quality feedback has been suspended.

3. The method of claim 2 wherein the first station suspends and resumes channel quality feedback depending on a channel quality threshold.

4. The method of claim 3 wherein the first station sends channel quality feedback when the channel conditions exceed the channel quality threshold and suspends channel quality feedback when channel conditions are below the channel quality threshold.

5. The method of claim 4 wherein said channel quality feedback comprises a channel quality indicator.

6. The method of claim 5 wherein the channel quality threshold is a minimum quality channel indicator value.

7. The method of claim 6 wherein the channel quality threshold is configurable by said second station.

8. The method of claim 7 wherein the first station receives the channel quality threshold from the second station.

9. The method of claim 1 wherein said channel quality feedback comprises rate control information.

10. The method of claim 9 wherein said first station sends a rate indication in a reporting period when said rate indication changes from a previous reporting period, and does not send said rate indication in a reporting period when said rate indication does not change from said previous reporting period.

11. A communication station comprising:
a receiver to receive packet data transmissions from a remote station over a forward link channel;
a transmitter to transmit channel quality feedback indicative of channel conditions on said forward link channel; and
a controller to control transmission of said channel quality feedback to said remote station, said controller operative to suspend said channel quality feedback dynamically responsive to changing channel conditions.

12. The communication station of claim 11 wherein the controller is further operative to resume said channel quality feedback dynamically responsive to changing channel conditions after said channel quality feedback has been suspended.

13. The communication station of claim 12 wherein said communication station suspends and resumes the channel quality feedback depending on a channel quality threshold.

14. The communication station of claim 13 wherein the communication station sends channel quality feedback when the channel conditions exceed a predetermined channel quality threshold and suspends channel quality feedback when channel conditions are below the channel quality threshold.

15. The communication station of claim 14 wherein the channel quality threshold is configurable.

16. The communication station of claim 15 wherein the communication station receives the channel quality threshold from the remote station.

17. The communication station of claim 16 wherein said feedback comprises a channel quality indicator.

18. The communication station of claim 11 wherein said channel quality feedback comprises a rate indication.

19. The communication station of claim 18 wherein the communication station sends a rate indication in a reporting period when said rate indication changes from a previous reporting period, and does not send said rate indication in a reporting period when said rate indication does not change from said previous reporting period.

20. A method of reducing channel quality feedback, comprising:
receiving channel quality feedback from a first station at a second station; and
sending qualification criteria from said second station to said first station to control transmission of said channel quality feedback from said first station.

21. The method of claim 20 wherein said qualification criteria comprises a channel quality threshold.

22. The method of claim 20 wherein said qualification criteria is established for a plurality of first stations individually.

23. The method of claim 20 wherein the same qualification criteria is used for a plurality of first stations.

24. A communication station comprising:
a transmitter to transmit packet data to one or more remote stations over a shared packet data channel;
a receiver to receive channel quality feedback from said remote stations; and
a controller to schedule transmissions to said remote stations over said packet data channel, said controller operative to send to said remote stations feedback qualification criteria for use by said remote stations to qualify said channel quality feedback prior to transmission to said communication station.

25. The communication station according to claim 24 wherein said feedback qualification criteria comprises a channel quality threshold.

26. The communication station of claim 24 wherein said controller establishes said qualification criteria for a plurality of first stations individually.

27. The communication station of claim 24 wherein said controller uses the same qualification criteria for a plurality of first stations.

28. A method of reducing signaling overhead in a mobile communication system, said method comprising:
sending control information from a first station to a second station over an overhead channel; and
temporarily suspending transmission of said control information in a current reporting period if said control information has not changed from a previous reporting period.

29. The method of claim 28 wherein said control information comprises a data rate used by the communication station for transmission on a packet data channel.

30. A communication station comprising:
a transmitter to transmit packet data to a remote station on a packet data channel and to transmit associated control information supporting said packet data channel on an overhead channel; and
a controller to control transmission of said control information to said remote station, said controller operative to temporarily suspend transmission of said control information in a current reporting period if said control information has not changed from a previous reporting period.

31. The communication station of claim 30 wherein said control information comprises a data rate used by the communication station for transmission on a packet data channel.
